(19) United States
(12) Patent Application Publication
(10) Pub. No.: US 2016/0224519 A1
(43) Pub. Date: Aug. 4, 2016

(54) MODIFICATION OF A PORTLET

(71) Applicant: International Business Machines Corporation, Armonk, NY (US)

(72) Inventors: Carsten A. Leue, Sindelfingen (DE); Jaspreet Singh, Delhi (IN)

(21) Appl. No.: 15/040,196

(22) Filed: Feb. 10, 2016

Related U.S. Application Data
(63) Continuation of application No. 14/613,408, filed on Feb. 4, 2015.

(51) Int. Cl. G06F 17/22; G06F 17/30; H04L 29/06

(52) U.S. Cl. CPC G06F 17/2247; H04L 67/42; G06F 17/30905

(57) ABSTRACT

Embodiments of the present invention provide systems, methods, and computer program products for modifying a published portlet. According to one embodiment, a server computer system renders a published portlet to a thin client interface of a client computer system. The server computer system receives a request for a design page of the portlet, renders the design page on the thin client interface, and receives modifications to the content of the portlet using the design page. Modified content of the portlet is stored as a portlet resource.

### BACKGROUND OF THE INVENTION

The present invention relates generally to the field of information technology, and more particularly to modification of a portlet.

Web portals and their constituents, portlets, are increasingly becoming a medium of choice for accessing information and applications within a network. A portal is an aggregate of reusable components called portlets. Portlets are pluggable software components that are managed and displayed in a web portal. It is through these portlets that a portal provides access to web content, applications and other network resources.

Generally, a portal page is displayed as a collection of non-overlapping portlet windows. Each of the non-overlapping portlet windows displays a portlet. These portlets individually bring in information and interface with different sources to present a unified view (i.e., portal) to the end user. While from the end user perspective, a portal is like a collection of windows (i.e., portlets), the portlets themselves are technically much more. Portlets are quite similar to other web technologies like servlets Like servlets, portlets are managed by a container, called a portlet container. A portlet container can include both static content (e.g., web based content) and dynamic part (e.g., application code). Once created, a portlet is published by the development environment onto a server. An individual can access the portlet from the server through a web browser. As part of portlet development, changes to portlet source code can be made in the development environment. The code can then be published to the server to see the updated portlet in a browser.

### SUMMARY

Embodiments of the present invention provide systems, methods, and program products for modifying a published portlet. In one embodiment of the present invention, a server computer system renders a published portlet to a thin client interface of a client computer system. The server computer system receives a request for a design page of the portlet, wherein content of the portlet is editable via the design page. The server computer system renders the design page of the portlet to the thin client interface. The server computer system receives modified content representing modifications made to content rendered by the design page. The server computer system stores the modified content of the portlet as a portlet resource.

### BRIEF DESCRIPTION OF THE DRAWINGS

FIG. 1 is a block diagram of an exemplary computer system, in accordance with an embodiment of the present invention;

FIG. 2 is a block diagram of an exemplary system for modifying a published portlet of a web application, in accordance with an embodiment of the present invention; and

FIG. 3 depicts an exemplary flow for a process, in accordance with an embodiment of the present invention.

### DETAILED DESCRIPTION

Some preferable embodiments will be described in more detail with reference to the accompanying drawings in which the preferable embodiments of the present disclosure have been illustrated. However, the present disclosure can be implemented in various manners and, thus. should not be construed to be limited to the embodiments disclosed herein. On the contrary, those embodiments are provided for the thorough and complete understanding of the present disclosure and completely conveying the scope of the present disclosure to those skilled in the art.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

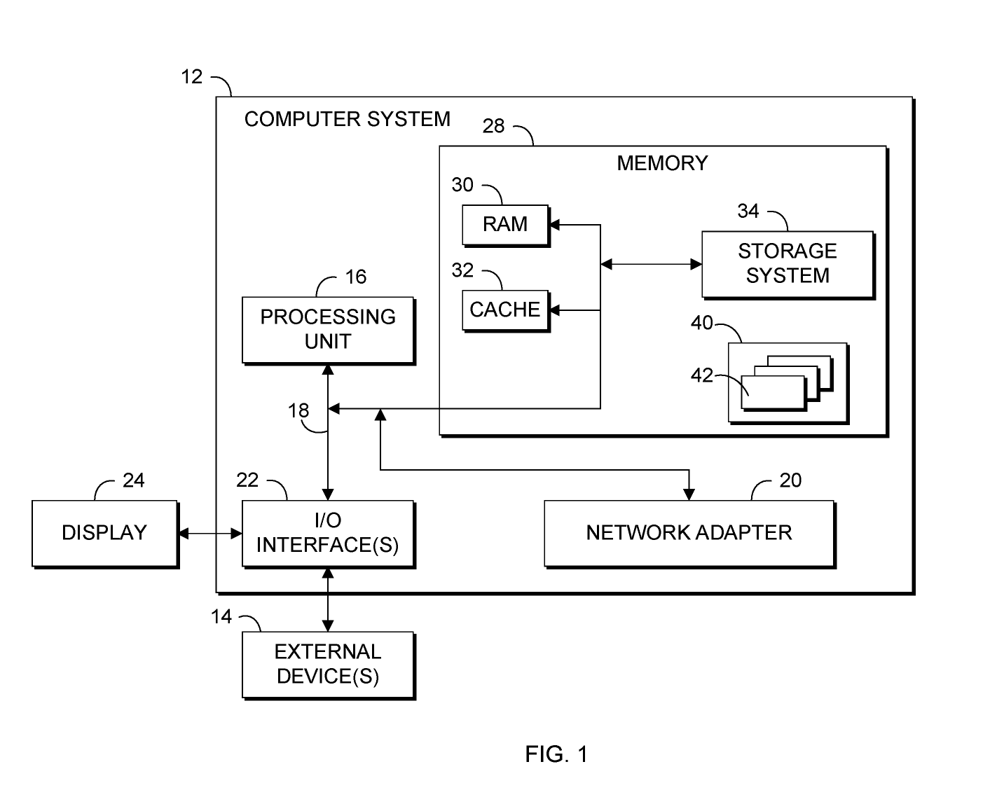

FIG. 1 is a block diagram of a computer system/server 12, in accordance with an embodiment of the present invention. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components, including system memory 28, to processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc., one or more devices that enable a user to interact with computer system/server 12, and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

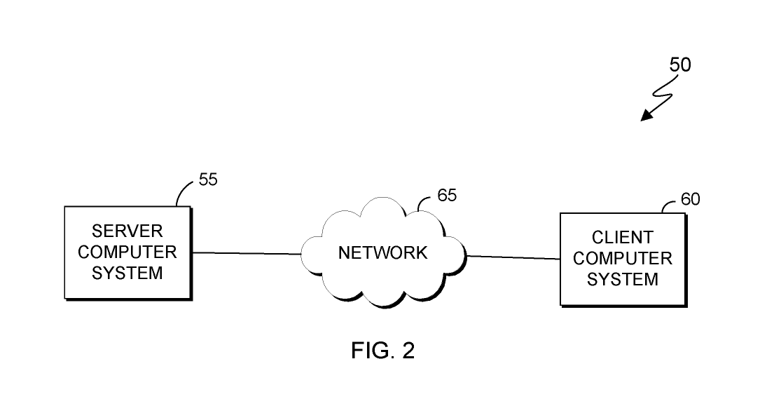

FIG. 2 is a block diagram of system 50 for modifying a published portlet of a web application, in accordance with an embodiment of the present invention. As shown in FIG. 2, system 50 includes server computer system 55 and client computer system 60 operatively connected by network 65. Server computer system 55 and client computer system 60 can be desktop computers, laptop computers, specialized computer servers, or any other computer systems known in the art. In certain embodiments, server computer system 55 and client computer system 60 represent computer systems utilizing clustered computers and components to act as a single pool of seamless resources when accessed through network 65. For example, such embodiments may be used in data center, cloud computing, storage area network (SAN), and network attached storage (NAS) applications. In certain embodiments, server computer system 55 and client computer system 60 represent virtual machines. In general, server computer system 55 and client computer system 60 are representative of any electronic devices, or combination of electronic devices, capable of executing machine-readable program instructions, as described in greater detail with regard to FIG. 1.

Network 65 can be, for example, a local area network (LAN), a wide area network (WAN) such as the Internet, or a combination of the two, and include wired, wireless, or fiber optic connections. In general, network 65 can be any combination of connections and protocols that will support communications between server computer system 55 and client computer system 60, in accordance with a desired embodiment of the invention.

Server computer system 55 may host one or more web applications, and a user may access the web applications hosted at server computer system 55 from client computer system 60 through a thin client interface such as a web browser. According to one embodiment of the present invention, the one or more web applications may be a portal comprising one or more portlets. A portlet is a specialized content area within a portal that occupies a small window in the portal. The portlet can process requests and generate dynamic content. In certain embodiments, a page may be embedded into the portlet using an iframe. A user can navigate through the embedded page. Typically, a portlet after creation is published onto the server computer system 55 so that a user may access the published portlet.

According to one embodiment of the present invention, a user accessing the published portlet via a thin client interface on the client computer system 60 may modify the published portlet via the thin client interface. To achieve this, the client computer system 60 may be configured to send a request for a design page of the portlet to the server computer system 55. The user may provide the indication for requesting the design page to the thin client interface of the client computer system 60 as an input. For example, the published portlet may have a “view mode” and a “design mode”, and the input may be provided using a graphical user interface (GUI) and clicking on a tab displayed for requesting the design page (i.e., selecting the design mode). The server computer system 55 on receiving the request for the design page of the portlet, renders the design page of the portlet to the thin client interface of the client computer system 60. The user can edit the contents of the design page of the portlet.

According to one embodiment of the present invention, the design page comprises an editor for displaying the JavaServer Pages (JSP) representing the user interface of the portlet. Providing the editor with the design page provides the advantage of displaying the JSP via the thin client interface. The JSP displayed on the editor may be edited by the user for modifying the portlet. The user may hence modify text, images, and other visual aspects of the portlet via the design page of the portlet.

According to one embodiment of the present invention, the content corresponding to the modification made to the portlet via the design page are stored at the server computer system 55 as a portlet resource. For example, the portlet resource may include, one or more of, a property file, a HyperText Markup Language (HTML) file, a JSP file and the like. This achieves in providing the advantage of modifying the contents of a published portlet via a thin client interface and avoiding restart of the server computer system 55 or the published portlet application. Also, as the content of the portlet is modified while the portlet is in published state, the requirement of a user modifying the portlet using an integrated development environment (IDE) module is eliminated. Modification of the portlet via the IDE module will require the modified portlet to be published again onto the server computer system 55, thus, making the modification process complex and time consuming.

According to one embodiment of the present invention, any changes made to a portlet published onto the server computer system 55 may be synchronized with the IDE module. For example, the IDE module may be implemented in the client computer system 60. According to one embodiment of the present invention, a drive of the client computer system 60 having the IDE module implemented may be mapped to a folder of the server computer system 55. Files or portlet resources associated with the portlet, modified via the design page, may be stored into the folder. Therefore, any changes or modification made to the published portlet files or resources may be communicated to the IDE module as the folder of the server computer system 55 and the drive of the client computer system 60 are mapped. In an embodiment, the drive of the client computer system 60 and the folder of the server computer system 55 may be mapped using a Web Distributed Authoring and Versioning (WebDAV) protocol.

According to another embodiment of the present invention, the client computer system 60 having the IDE module implemented therein may poll the server computer system 55 for changes or modifications to the portlet files or resources. For example, the IDE module may send a polling message to the server computer system 55 to poll if any modifications or changes are made to the portlet resources. The server computer system 55 is configured to receive the polling message and respond to the same. Thus, the IDE module is synchronized with any changes or modifications made to the content of the portlet on the server computer system 60.

For example, according to one embodiment of the present invention, the content corresponding to the modification made to the portlet, text, title etc. via the design page are stored at the server computer system 55 as a property file. The server computer system 55 may be configured to create a property file for storing the modified content for each instance. This leads to dynamic generation of a new resource bundle for the portlet that merges these modifications to the bundle over the entries that are already deployed with the portlet.

According to one embodiment of the present invention, a portlet refresh may update the contents of the published portlet with the modified contents from the appropriate modified portlet resource for example, portlet JSP, HTML file, or property file. For example, the server computer system 55 may be configured to refresh the published portlet once the modifications are submitted by the user. The modified contents are retrieved from the portlet resource.

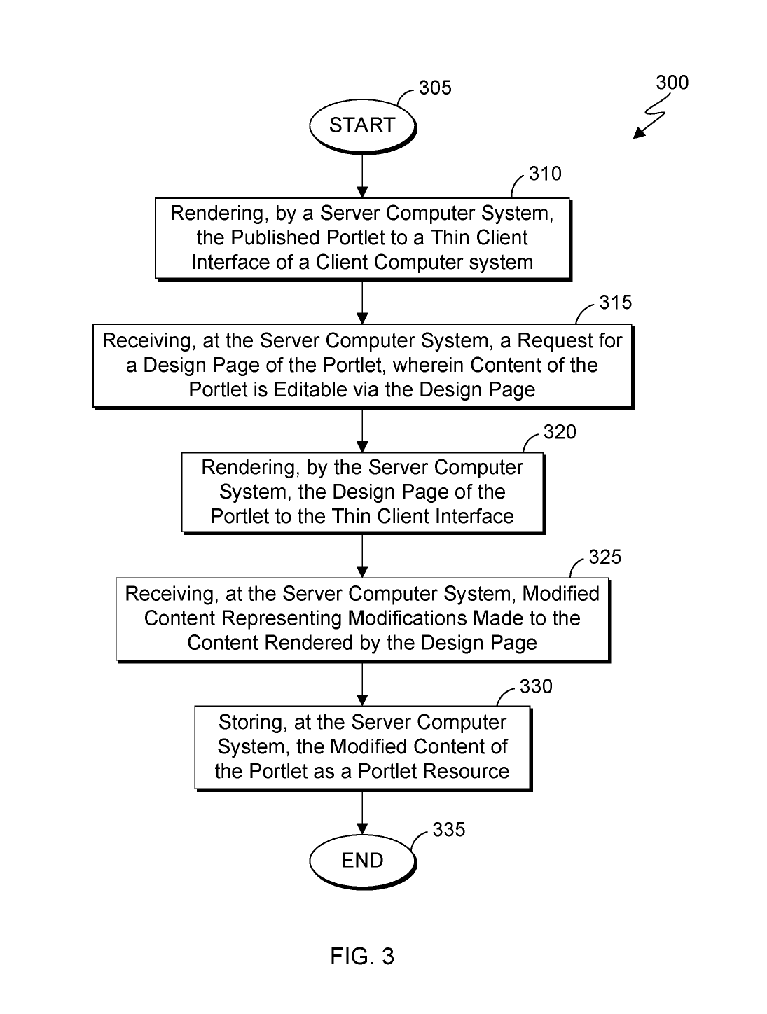

FIG. 3 depicts an exemplary flow for a process 300 in accordance with aspects of the present invention. Process 300 can be performed, for example, by the computer system 12 of FIG. 1.

At step 305, the process starts, and at step 310, a published portlet is rendered to a thin client interface of a client computer system (e.g., the client computer system 60 in FIG. 2) by a server computer system (e.g., the server computer system 55 in FIG. 2). The portlet may be published on the server computer system 55. A user may access the published portlet at a client computer system via a thin client interface. The server computer system may render the portlet to the thin client interface.

At step 315, a request for a design page of the portlet is received at the server computer system. Content of the portlet is editable via the design page.

At step 320, the server computer system renders the design page of the portlet to the thin client interface responsive to the request for the design page.

At step 325, the server computer system receives a modified content representing modifications made to the content rendered by the design page. The contents of the design page may be modified by a user.

Next, at step 330, the sever computer system stores the modified content of the portlet as a portlet resource and, at step 335, the process ends.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method of modifying a published portlet, the method comprising:
rendering, by a server computer system, a published portlet to a thin client interface of a client computer system;
receiving, at the server computer system, a request for a design page of the portlet, wherein content of the portlet is editable via the design page;
rendering, by the server computer system, the design page of the portlet to the thin client interface;
receiving, at the server computer system, modified content representing modifications made to content rendered by the design page; and
storing, at the server computer system, the modified content of the portlet as a portlet resource.

2. The method of claim 1, further comprising:
providing the modified content to an integrated development environment (IDE) module for synchronization.

3. The method of claim 2, wherein providing the modified content to the IDE module for synchronization comprises:
mapping a drive associated with the IDE module and a folder of the server computer system associated with the portlet resource.

4. The method of claim 2, wherein providing the modified content to the IDE module for synchronization comprises:
receiving, at the server computer system, a polling message for changes.

5. The method of claim 1, wherein the design page comprises an editor displaying a script corresponding to the portlet.
